(19) United States
(12) Patent Application Publication
(10) Pub. No.: US 2005/0246177 A1
(43) Pub. Date: Nov. 3, 2005

(54) System, method and software for enabling task utterance recognition in speech enabled systems

(75) Inventors: Randall Long, Florissant, MO (US); Benjamin A. Knott, Round Rock, TX (US); Robert R. Bushey, Cedar Park, TX (US)

Correspondence Address: BAKER BOTTS L.L.P.;PATENT DEPARTMENT, 98 SAN JACINTO BLVD., SUITE 1500, AUSTIN, TX, 78701-4039, US

(73) Assignee: SBC Knowledge Ventures, L.P.

(21) Appl. No.: 10/836,029

(22) Filed: Apr. 30, 2004

(51) Int. Cl. G10L 15/00

(52) U.S. Cl. 704/275

(57) ABSTRACT

A system, method and software for collecting, processing and analyzing user task utterances in speech-enabled systems are provided. In one embodiment, a number of task utterances are captured over a period of time. A text-based version of the utterances is created from the captured utterances. The captured task utterances, the text-based utterances and an identification record are preferably placed in storage. The text and/or recorded utterances are categorized into action-object pairs. The identification records and recorded utterances are linked. From the linked, categorized text and recorded utterances, speech grammars for a speech-enabled system may then be developed.

### TECHNICAL FIELD OF THE INVENTION

The present invention relates generally to the provision of automated service systems and, more particularly, to collecting, processing and analyzing customer task utterance data.

### BACKGROUND OF THE INVENTION

Logically, an important component in the implementation of a speech recognition application is the ability of the application to recognize speech. To this end, tremendous amounts of time, effort and money are spent developing the ability of speech recognition applications to understand natural language utterances. One object of these development expenditures is the creation of speech recognition grammars.

In general, speech recognition grammars tell a speech recognition application what words may be spoken, patterns in which those words may occur, and spoken language of each word. As such, speech recognition grammars intended for use by speech recognition applications and other grammar processors permit speech scientists to specify the words and patterns of words to be listened for by a speech recognition application.

With speech recognition grammars forming a fundamental component an effective speech recognition application, much importance is placed on their development. However, despite this importance, current methodologies for developing these grammars are wanting in a variety of aspects, and in particular, lack the focus and systematic approach to yield a robustness and relevance required by customers and users of the associated speech-enabled systems.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 is a flow diagram depicting an exemplary embodiment of a method for building speech-enabled applications or systems according to teachings of the present invention;

FIG. 2 is a flow diagram depicting another exemplary embodiment of a method for building speech-enabled applications or systems according to teachings of the present invention; and

FIG. 3 is a block diagram depicting an exemplary embodiment of a system for building speech-enabled applications or systems according to teachings of the present invention.

### DETAILED DESCRIPTION OF THE INVENTION

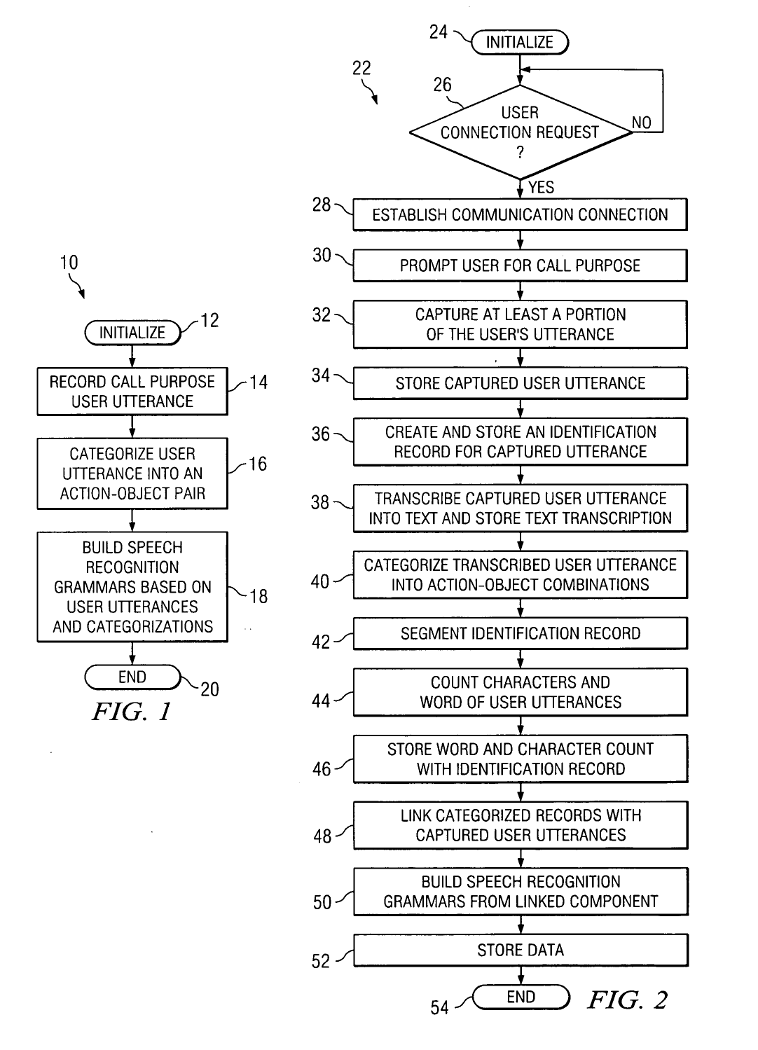

Preferred embodiments and their advantages are best understood by reference to FIGS. 1 through 3, wherein like numbers are used to indicate like and corresponding parts.

Referring first to FIG. 1, a flow diagram depicting an exemplary embodiment of a method for building a speech-enabled application incorporating teachings of the present invention. In one aspect, teachings of the present invention provide a method of capturing, categorizing and leveraging a sampling of user utterances in the development of speech recognition application grammars. However, it should be understood that teachings of the present invention may be employed in a variety of other circumstances.

As illustrated in FIG. 1, method 10 preferably begins upon initialization at 12. Upon initialization at 12, method 10 preferably proceeds to 14.

In an exemplary embodiment of teachings of the present invention, method 10, at 14, preferably provides for the recording of a call purpose user utterance. In one embodiment, a user contacting a system implementing teachings of the present invention may be prompted to state a purpose for their current system contact. After prompting, upon detection of a user utterance or after a predetermined time delay, method 10 preferably provides for the capture, such as by recording, of at least a portion of the user's utterance of a call purpose responsive to system prompting. Following the capture or recording of the desired extent of the call purpose utterance, method 10 preferably proceeds to 16.

The recorded or captured user utterances or user utterance segments are preferably categorized into action-object pairs or combinations at 16 of method 10 in an exemplary embodiment. As used in the present disclosure, action-object pairs or combinations may be generally defined as processing or informational objects available from a selected application or system and actions associated with each respective object and available from the associated application or system, the actions operable to be selectively performed by the application or system.

In one embodiment, a system may be employed to extract and categorize, from the recorded user utterances, the associated action-object pairs. In an alternate embodiment, an existing library of action-object pairings or combinations may be available to a categorization engine which compares language extracted from the recorded user utterances to the existing action-object pairs to perform the categorizing operations of method 10. In a further embodiment, a portion of the user utterance action-object categorizations may be performed by an automated categorization engine and the remainder of the user utterance action-object categorization may be performed manually.

For example, in a telephone service call center application or system, a series of action-objects may be available for user selection where the action-object pairs are related to the provision of telephone services. If a “Bill” object were available, actions that may be associated with the Bill object include, without limitation, inquire, pay, dispute, check last payment post date, etc. Similarly, a telephone service provider call center may make available a “CallNotes” object with available actions including, without limitation, setup, change password, cancel, add, determine availability and pricing. Myriad other action-object combinations or pairs are possible within a telephone service provider call center system or application as well in other applications or systems.

In a further example, suppose the call purpose user utterance recorded at 14 included the statement “How do I change my CallNotes service?”. In an exemplary embodiment, method 10, at 16, may categorize the recorded user utterance according to the action-object pair of “Change-CallNotes.”

Following categorization of a call purpose user utterances at 16, method 10 preferably proceeds to 18 in an exemplary embodiment of the present invention. At 18 method 10 preferably provides for the building of speech recognition grammars based on the recorded user utterances and the action-object combination categorizations.

In one aspect, speech recognition grammars may be built by speech scientists. In an alternate embodiment, an automated system or application may be employed to develop portions or all of the speech recognition grammars to be employed by a particular speech recognition application. Depending upon implementation, speech recognition grammars may include data that suggests what a speech recognition application or system should listen for, such as words likely to be spoken, patterns in which selected words may occur, spoken language of each word, as well as other utterance recognition hints. Method 10 preferably ends at 20 following the building of speech recognition grammars at 18.

Referring now to FIG. 2, an alternate exemplary embodiment of a method for building speech-enabled applications or systems according to teachings of the present invention is shown. As with method 10 of FIG. 1, method 22 may be leveraged in the creation of a speech-enabled call center service solution as well as in the creation and implementation of other speech-enabled solutions.

Upon initialization at 24, method 22 proceeds to 26 where a user connection request may be awaited, in an exemplary embodiment. If at 26 a user connection request is not detected, method 22 preferably remains in a wait state or loops until a user connection request is detected.

Upon detection of a user connection request at 26, method 22 preferably proceeds to 28. A communication connection is preferably established with the requesting user at 28.

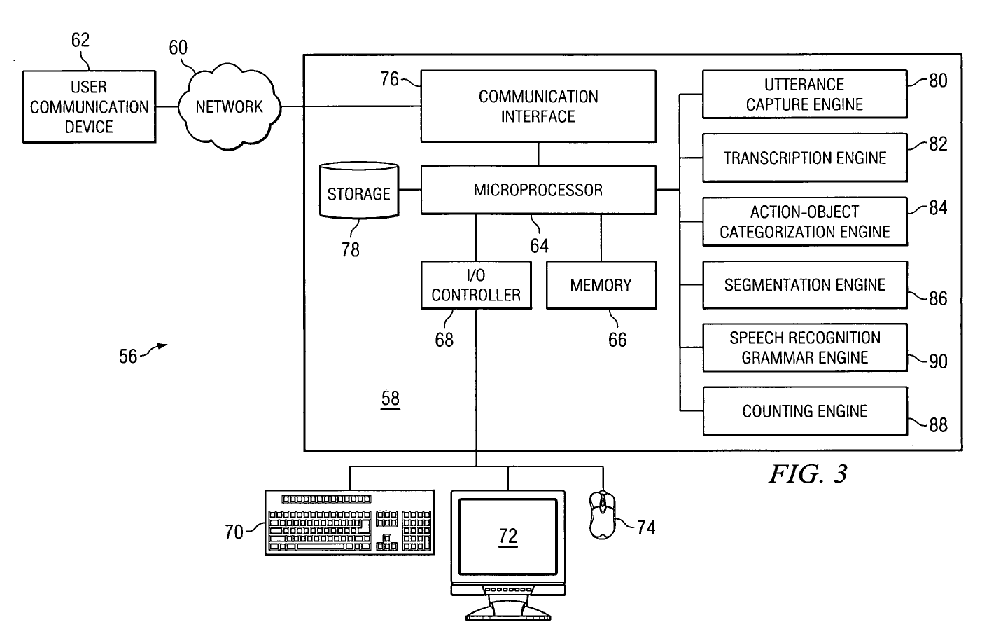

Depending upon implementation, methods 10 and 22 may be implemented in a variety of configurations. In one exemplary implementation, a testing and development call center system may be constructed to receive a plurality of staged customer service calls to which the operations of methods 10 and/or 22 may be applied. In an alternate exemplary implementation, methods 10 and/or 22 may be deployed in a live or operational call center where actual customer service requests are being received and acted upon by services available from the call center. Generally, as discussed in greater detail below with respect to FIG. 3, methods 10 and 22 may be implemented in a computer system capable of receiving one or more user contacts via at least one telecommunication network. The computer system is preferably also operable to perform some or all of the operations discussed in methods 10 and 22.

Following the establishment of a user communication connection at 28, method 22 preferably proceeds to 30. At 30 the connected user is preferably prompted for entry of call purpose. In an exemplary embodiment, the user is requested to state, in their own words, a request for transaction processing, information or other purpose of the instant connection. For example, method 22 may provide for prompting a user with “Welcome to the customer service center. Please say the purpose of your call.” Alternative prompts are contemplated within the spirit and scope of the present invention.

Following prompting the user to state a call purpose at 30, method 22 proceeds to 32 where at least a portion of a user utterance responsive to the prompting is captured, in an exemplary embodiment.

Capturing at least a portion of a user utterance at 32 may include recording the user utterance in its entirety, recording a defined segment of the user utterance, recording a defined timeframe of the user utterance, etc. In an exemplary embodiment, capturing of the user utterance responsive to call purpose prompting includes capturing at least ten (10) seconds of the user utterance.

Initiation of user utterance capture may occur in a variety of instances. For example, a system implementing method 22 may begin recording immediately following the communication of a call purpose prompt to the user. In an alternate embodiment, a system implementing method 22 may begin recording after a defined time delay, giving the user time to formulate a response to the call purpose prompting. In still another embodiment, a system implementing method 22 may await detection of a user utterance before beginning user utterance capture or recording operations. Alternative implementations of the timing of capturing a user utterance responsive to prompting may be implemented without departing from the spirit and scope of the present invention.

Following capture of at least a portion of the user utterance or utterances responsive to call purpose prompting, method 22 proceeds to 34 in an exemplary embodiment. At 34 method 22 preferably provides for the captured user utterance data to be stored in one or more fixed storage devices such as a hard drive device, one or more storage devices in a storage area network, one or more removable storage media, as well as other storage technologies.

In an exemplary embodiment of method 22, creation of an identification record for each captured user utterance is preferably occasioned at 36. In addition, method 22 preferably also provides for storage of the identification record at 36.

An identification record, according to an exemplary embodiment of the present invention, may include data indicative of the user utterance or user connection occurrence. For example, an identification record created and stored at 36 of method 22 may include data indicative of the time the user connection request was received, when the user utterance was captured, etc. In addition, an identification record created and stored at 36 of method 22 may include the date on which the user call was received or the user utterance was captured, information identifying the call center to which the user was connected, a call center provider region associated with the handling call center, details regarding the hardware processing the user connection such as a line number, supporting network, etc.

Having captured and stored user utterances responsive to call purpose prompting and having created and stored identification records associated with the captured user utterances, method 22 preferably proceeds to 38. In an exemplary embodiment of method 22, provision is made for the transcription of the captured user utterances at 38. Preferably, the captured user utterances are transcribed into one or more text formats. The transcribed user utterances are preferably also stored in one or more storage media at 38.

Following transcription of the captured and stored user utterances at 38, method 22 preferably proceeds to 40. At 40 method 22 preferably provides for the categorization of the user utterances into action-object pairs or combinations. Depending upon implementation, categorization of user utterances into action-object pairs may be performed on the captured user utterances, the transcribed user utterances, some combination thereof or otherwise.

In an exemplary embodiment of the present invention, the categorization of user utterances into action-object pairs may be performed under a variety of conditions. For example, in an exemplary embodiment, a program of instruction designed to parse user utterances, either captured or transcribed, is preferably executed to perform at least a portion of user utterance action-object categorizations. Further, in such an embodiment, categorization of the remaining portion of user utterances is preferably performed manually, e.g., by one or more live personnel. In other embodiments, the entirety of user utterances, either captured or transcribed, may be categorized manually or using the program of instructions

At 42 of method 22 the identification records previously created and stored are preferably segmented. Such segmentation may create an easily searchable database of caller, call and user utterance data. In an exemplary embodiment of the present invention, segmenting the identification record may include breaking the identification records out into their components parts. For example, a segmented identification record may have a date segment, time segment, line number segment, call center segment, region segment, etc.

Following the segmentation of identification records at 42, method 22 preferably proceeds to 44. At 44, in an exemplary embodiment, a program of instructions designed to count the number of words and characters in the captured and stored user utterances is preferably executed. In an alternate exemplary embodiment, the word and character count of the user utterances may be otherwise performed. Similar to operations discussed above, the word and character count may be performed on either the recorded user utterances, the transcribed user utterances or some combination thereof. The word and character counts are preferably stored with their associated identification records at 46.

At 48, the captured and stored user utterances are preferably linked with the categorized user utterances at 40. In an exemplary embodiment, linking user utterances with the categorized user utterances may include linking common or substantially similar identification records.

Following the linking of the categorized user utterances with the captured and stored user utterances at 48, method 22 preferably proceeds to 50. At 50 speech recognition grammars may be developed based on the action-object pairings, the captured and stored user utterances, as well as the other information created and/or obtained in method 22. A variety of methodologies exist which may be employed with the teachings of the present invention to develop speech recognition grammers from the data formed and obtained in accordance with the teachings of methods 10 and/or 22. At 52 of method 22, data desired to be preserved is preferably stored before method 22 ends at 54.

Referring now to FIG. 3, an exemplary embodiment of a computer system incorporating teachings of the present invention is shown. As mentioned above, teachings of the present invention may be implemented in a test facility setup, at least in part, to enable the building of speech recognition grammars and the facilitation of one or more speech-enabled applications. Alternatively, as mentioned above, teachings of the present invention may be implemented alongside customer service technologies deployed in a live call center. As such, the system depicted generally in FIG. 3 is representative of a system capable of effecting methods 10 and 22.

System 56 of FIG. 3 preferably includes computer or information handling system 58. Computer system 58 is preferably coupled via one or more communications networks 60 to one or more user communication devices 62.

In an exemplary embodiment, communication network 60 may be formed from one or more communication networks. For example, communication network 60 may include a public switched telephone network (PSTN), a cable telephony network, an IP (Internet Protocol) telephony network, a wireless network, a hybrid Cable/PSTN network, a hybrid IP/PSTN network, a hybrid wireless/PSTN network or any other suitable communication network or combination of communication networks. In addition, one of ordinary skill may appreciate that other embodiments can be deployed with many variations in the number and type of I/O devices, communication networks, the communication protocols, system topologies, and myriad other details without departing from the spirit and scope of the present invention.

In a further exemplary embodiment, user communication devices 62 may include telephones (wireline or wireless). In addition, user communication devices 62 may incorporate one or more speech transceivers operably coupled to dial-up modems, cable modems, DSL (digital subscriber line) modems, phone sets, fax equipment, answering machines, set-top boxes, televisions, POS (point-of-sale) equipment, PBX (private branch exchange) systems, personal computers, laptop computers, personal digital assistants (PDAs), SDRs, other nascent technologies, or any other appropriate type or combination of communication equipment available to a user. User communication device 62 is preferably equipped for connectivity to communication network 60 via a PSTN, DSLs, a cable network, a wireless network, or any other appropriate communications channel.

As depicted in FIG. 3, computer system 58 preferably includes one or more microprocessors 64. Communicatively coupled to microprocessor 64 is memory 66. In operation, memory 66 and microprocessor 64 preferably cooperate to store and execute, respectively, at least one program of a program of instructions.

Computer system 58 preferably also includes one or input/output (I/O) controllers or devices 68. As shown in FIG. 3, I/O controllers 68 preferably enable one or more I/O devices to be operably coupled to computer system 58. I/O devices that may be used with computer system 58 include, without limitation, keyboard 70, video display 72 and mouse 74. I/O controllers 68, in the illustrated embodiment, may include one or more serial, video, universal serial bus, fire-wire, wireless, or other ports compatible with computer system 58.

In part to facilitate the communication with a user at a user communication device 62, one or more communication interfaces 76 are preferably included in computer system 58. One or more communication interfaces 76 preferably coupled to a respective one or more communication ports (not expressly shown) which enable a plurality of users to communicate with computer system 58. The provision of a plurality of communication interfaces 76 and associated communication ports enables large volumes of information to be collected in shorter amounts of time than could be collected with one or only a few communication interfaces 76 and associated communication ports. In one embodiment, sufficient ports in a computer system or call center may be tapped such that at least twelve thousand (12,000) user utterances may be captured within a three to five (3-5) day window of time. Other time frames and utterance volumes are contemplated by the present invention.

As illustrated in FIG. 3, computer system 58 preferably includes a plurality of engines capable of effecting all or portions of methods 10 and 22 as well as derivatives thereof. The engines preferably included in computer system 58 may be implemented in one or more programs of instructions, in one or more hardwired components, or some combination thereof. Computer system 58 preferably also includes one or more storage devices 78 operable to cooperate with the various engines and other aspects of computer system 58.

In an exemplary embodiment, computer system 58 may include utterance capture engine 80. As suggested above with respect to methods 10 and 22, utterance capture engine 80 is preferably operable to record or sample at least a portion of a user utterance responsive to a call purpose prompt communicated to the user. Utterance capture engine 80 may also cooperate with storage 78 to store the captured user utterances.

In an exemplary embodiment, computer system 58 may also include transcription engine 82. As suggested above, transcription engine 82 may be operable to transcribe the user utterances captured and stored by utterance capture engine 80 to create a text-based form of the captured and stored user utterances. Like utterance capture engine 80, transcription engine 82 may cooperate with storage 78 to preserve and store the transcribed utterances.

As mentioned above, at least a portion of the categorizing of user utterances into action-object pairs is preferably performed by one or more automated systems. In an exemplary embodiment, action-object categorization engine 84 may be operable to perform action-object pairing categorizations on the captured and stored user utterances and/or on the transcribed user utterances. Live personnel may be able to perform manual action-object pairing categorizations using I/O devices 70, 72 and 74 with or without the aid of action-object categorization engine 84. Storage 78 may also cooperate with action-object categorization engine 84 to store the action-object pair categorizations.

Segmentation engine 86 and counting engine 88 may also be included in an exemplary embodiment of computer system 58. As suggested above, a segmentation engine 86 is preferably included and operable to segment the identification records created with the captured and stored user utterances into one or more data fields. Counting engine 88 preferably performs the desired character and word counting on the transcribed or captured and stored user utterances as describe above. Similar to the other engines of computer system 58, segmentation engine 86 and counting engine 88 may cooperate with storage 78 to retain the information and data they create or obtain.

In an implementation where the building or creation of one or more speech grammars may be automated, speech recognition grammars engine 90 may be included in computer system 58. In an alternate implementation, capabilities included in speech recognition grammars engine 90 may be leveraged by a speech scientist in the building or creation of speech grammars for a speech-enabled application.

Although the disclosed embodiments have been described in detail, it should be understood that various changes, substitutions and alterations can be made to the embodiments without departing from their spirit and scope. For example, computer system 58 may incorporate additional engines operable to perform the operations discussed or suggested above with respect to methods 10 and 22. Further, computer system 10 may combine the functionality of one or more engines into a single engine or varying pluralities of engines. In addition, computer system 58 may be implemented within a telephone call center or may be replaced by comparable components within a call center. Still further modifications may be made to the disclosure herein without departing from the teachings of the present invention.

1. A method for enhancing task utterance recognition capabilities in speech enabled systems, comprising:
prompting a customer to speak a purpose of their call;
recording a predetermined amount of a user utterance responsive to the prompting;
storing the recorded user utterance;
storing with the recorded user utterance an identification field including at least a call time, call date, call center and region information;
repeating the prompting, recording and storing operations for a predefined number of user utterances over a predefined period of time;
transcribing the recorded user utterances into a text format;
storing the text format user utterances in a database;
executing an automated computer program designed to categorize at least a portion of the transcribed user utterances into action-object pairs;
categorizing, manually, at least a portion of the transcribed user utterances into action-object pairs;
executing an automated computer program operable to segment the stored identification records;
executing an automated computer program operable to count a number of characters and words included in each recorded user utterance;
storing the number of characters and the number of words;
linking the categorized user utterances with the recorded user utterances; and
building grammars for use in a speech recognizer in accordance with the linked information.

2. Software for collecting, processing and analyzing customer task utterances, the software embodied in computer readable media and when executed operable to:
record a predetermined number of user task utterances within a predetermined time period;
categorize, where possible, each user task utterance in accordance with one or more action-object pairs; and
build speech recognition grammars based on the recorded user task utterances and the categorizations.

3. The software of claim 2, further operable to transcribe the recorded user utterances into a text format.

4. The software of claim 2, further operable to store the recorded user utterances in a first storage location.

5. The software of claim 4, further operable to store an identification field with the stored recorded user utterances.

6. The software of claim 5, further operable to:
link the categorized user task utterances with the recorded user task utterances by identification field; and
build grammars for the speech recognizer based on the linked information.

7. The software of claim 5, further operable to store an identification including at least a time, data, recipient location and origination location of the user utterance.

8. The software of claim 2, further operable to categorize at least a portion of the user task utterances using a computer implemented categorization routine.

9. The software of claim 2, further operable to accept manual action-object categorization assignments for at least a portion of the user task utterances.

10. The software of claim 2, further operable to:
count a number of characters and a number of words associated with each categorized user task utterance; and
store the word and character count with an associated recorded user task utterance.

11. A method for collecting, processing and analyzing user task utterances, comprising:
recording a plurality of user task utterances responsive to a prompt requesting customer entry of purpose of a call;
creating a text version of the recorded user task utterances;
associating the recorded user task utterances and the text versions of the recorded user task utterances with an action-object pair; and
forming speech recognizer grammars based on the action-object pair associations.

12. The method of claim 11, further comprising:
storing the recorded plurality of user task utterances; and
storing an identification field with the recorded user task utterances, the identification field including at least a time and date of the user task utterance and a character and word count of an associated user task utterance.

13. The method of claim 11, further comprising recording a predetermined number of user task utterances over a predetermined period of time.

14. The method of claim 11, further comprising:
associating at least a portion of the recorded user task utterances and the text versions of the recorded user task utterances with an action-object pair using an automated computer program; and
manually associating at least a portion of the recorded user task utterances and the text versions of the recorded user task utterances with an action-object pair.

15. A system for collecting, processing and analyzing user task utterances, comprising:
memory;
at least one processor operably associated with the memory;
a communication interface operable to receive communications from one or more user devices; and
a program of instructions storable in the memory and executable in the processor, the program of instructions operable to prompt callers to state a purpose of their call, record task utterances responsive to the prompt, store the recorded task utterances, create a text-based copy of the task utterances and instruct a speech recognizer as to action-object recognition based on grammars built from categorizations of the recorded task utterances and the text-based copies.

16. The system of claim 15, further comprising the program of instructions to categorize at least a portion of the recorded task utterances according to available action-object pairings.

17. The system of claim 16, further comprising the program of instructions operable to accept manual categorization of at least a portion of the recorded task utterances according to the available action-object pairings.

18. The system of claim 15, further comprising the program of instructions operable to obtain a predetermined number of task utterance recordings over a predetermined period of time.

19. The system of claim 15, further comprising the program of instructions operable to segment an identification field stored with the recorded task utterances, the identification field including at least a time, date, geographic origination and destination of an associated task utterance.

20. The system of claim 15, further comprising the program of instructions operable to:
count a number of words and characters in at least a portion of the recorded task utterances; and
store the word and character count in an identification files associated with a corresponding task utterance.
